(19) United States
(12) Patent Application Publication
(10) Pub. No.: US 2020/0145836 A1
(43) Pub. Date: May 7, 2020

(54) WIRELESS LOCAL AREA NETWORK WITH RELIABLE BACKHAUL BETWEEN ACCESS POINTS

(71) Applicant: CommScope Technologies LLC, Hickory, NC (US)

(72) Inventor: Trevor D. Smith, Eden Prairie, MN (US)

(73) Assignee: CommScope Technologies LLC, Hickory, NC (US)

(21) Appl. No.: 16/676,263

(22) Filed: Nov. 6, 2019

Related U.S. Application Data
(60) Provisional application No. 62/756,864, filed on Nov. 7, 2018.

(51) Int. Cl. H04W 16/14; H04W 4/10; H04B 7/0413; H04W 88/14; H04N 21/436

(52) U.S. Cl. CPC H04W 16/14; H04W 4/10; H04W 84/12; H04W 88/14; H04N 21/436; H04B 7/0413

(57) ABSTRACT

A wireless local area network is provided. The wireless local area network includes a plurality of access points distributed in a location, wherein the access points form a mesh network. The access points are configured to communicate with client stations over a frequency band dedicated to wireless local area networks. The access points are further configured to communicate backhaul data with each other over a reliable backhaul communication link.

### CROSS REFERENCE TO RELATED APPLICATIONS

This application claims the benefit of U.S. Provisional Patent Application No. 62/756,864, filed on Nov. 7, 2018 and titled “WIRELESS LOCAL AREA NETWORK WITH RELIABLE BACKHAUL BETWEEN ACCESS POINTS” the disclosure of which is incorporated herein by reference.

### BACKGROUND

Wireless local area networks (WLAN) have become commonplace in modern homes. Such networks are used to deliver data between the Internet and various devices in the home, including, computers, mobile phones, and televisions. More recently, other appliances and devices in the home have begun to take advantage of this data pipeline. Refrigerators, dishwashers and other appliances are becoming more sophisticated and can send and receive data through the home WLAN thus implementing the so-called Internet-of-things (IoT).

Common WLAN technology is built on shared frequency channels in the 2.4 GHz and 5 GHz bands that are accessed on a “listen before use” protocol. Additional bands are expected to be added in the future including 6 GHz and 60 GHz. In these WLAN networks, data is transmitted between a wireless access point and user devices over these unlicensed channels. The home environment includes many obstacles that interfere with these transmissions including: walls, floors, ceilings, pipes, heating ducts, and other obstacles that impede radio frequency (RF) propagation. To provide better WLAN coverage throughout a home, it is often necessary to use several access points that form a mesh network with data communicated between the access points over the same unlicensed spectrum used to carry data between end user devices and the access points in the mesh network. Thus, the mesh network achieves the desired coverage at the expense of reducing the bandwidth available to the end user devices.

As the number of devices in the home competing for access to the WLAN increases, the effective bandwidth of the WLAN will decrease due to the increased traffic between access points in the Mesh network (so-called backhaul data) and due to the increase in the number of devices that need to “listen before talk.” Each new device slows down the network incrementally because the new device needs a time slot to listen. The mesh partially compensates for this reduction in bandwidth because not every device communicates with every access point In the mesh, but the mesh uses bandwidth for the backhaul data. Further, in multi-dwelling units, many WLANs also compete for access to the same, limited frequency spectrum. Thus, this effective reduction in bandwidth of the WLAN, left unchecked, will become a bottleneck in the information highway of the Internet-of-things.

### SUMMARY

A wireless local area network is provided. The wireless local area network includes a plurality of access points distributed in a location, wherein the access points form a mesh network. The access points are configured to communicate with client stations over a frequency band dedicated to wireless local area networks. The access points are further configured to communicate backhaul data with each other over a reliable backhaul communication link.

### BRIEF DESCRIPTION OF THE DRAWINGS

FIG. 1 is a block diagram of one embodiment of a wireless local area network with a reliable backhaul communication link.

FIG. 2 is a flow diagram that illustrates one embodiment of a process for allocating licensed spectrum for use as the reliable backhaul communication link.

FIG. 3 is a flow chart that illustrates one embodiment of a process for allocating a channel in a shared access spectrum to a reliable backhaul communication link.

FIG. 4 is a block diagram that illustrate one embodiment of a set top box.

FIG. 5 is a block diagram that illustrates one embodiment of a home gateway.

FIG. 6 is a flow chart that illustrates one embodiment of a process for upgrading or adding a feature to a home gateway or wireless local area network.

FIG. 7 is a flow chart that illustrates another embodiment of a process for upgrading or adding a feature to a home gateway or wireless local area network.

FIG. 8 is a block diagram illustrating one exemplary embodiment of a WLAN cluster that implements a technique for frequency reuse.

FIG. 9 is a flow diagram illustrating one exemplary embodiment of a method 900 of reusing a frequency in a wireless local area network.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

I. Reliable Backhaul

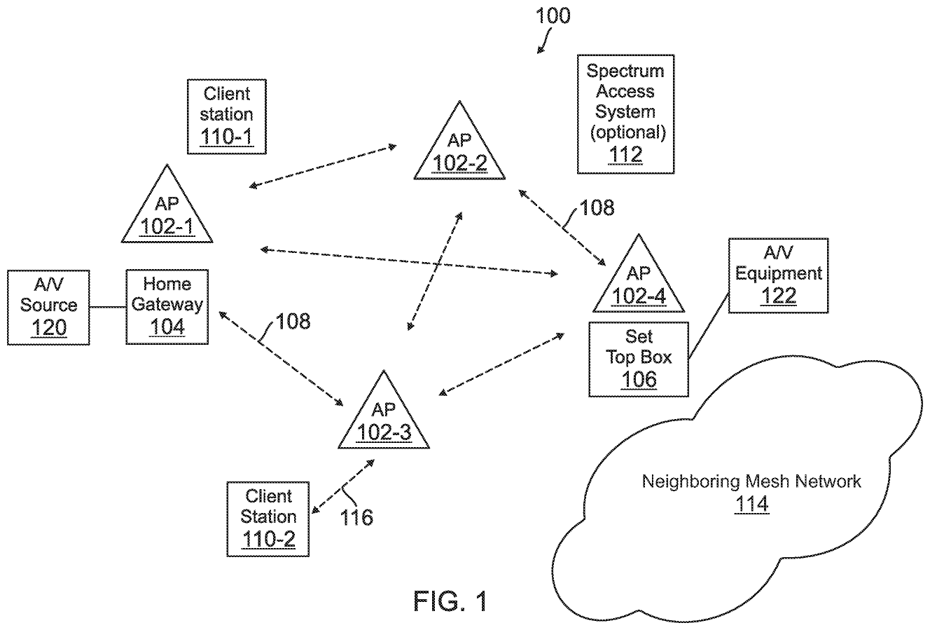

To improve performance of wireless local area networks (WLANs), embodiments of the present invention include a so-called “reliable backhaul” to carry data between Access Points (APs) in the WLAN. This is shown by way of example with respect to WLAN 100 of FIG. 1. WLAN 100 includes several access points 102. For pedagogical purposes, WLAN 100 is shown as a mesh network with four access points 102 identified as access points 102-1, 102-2, 102-3, and 102-4. Each of the access points 102 has a reliable backhaul communication link 108 with each of the other access points 102 of the WLAN 100. In other embodiments, WLAN 100 may use a “hub and spoke” configuration with a primary or controller access point and a number of additional access points that communicate with the primary access point over the reliable backhaul communication link 108. In other embodiments, the reliable communication channel is used as a control channel for WLAN 100 and additional chunks of spectrum are brought in to augment the reliable backhaul communication link 108 when needed.

As is conventional, WLAN 100 uses a portion of an unlicensed frequency band to create a channel or channels to communicate with client stations 110. Conventionally, a different portion of this same, unlicensed frequency band is used for backhauling communication between the access points in the mesh network. As discussed above, this use of the same, unlicensed frequency band for the backhaul communication reduces the available bandwidth in the unlicensed frequency band for user data. To alleviate the burden on this unlicensed frequency band, WLAN 100 uses another frequency band to implement the reliable backhaul communication link 108. Several options for the other communication band are described in turn below.

A. Licensed Communication Band

For example, in one embodiment, WLAN 100 uses channels in a frequency band that is licensed to an operator (so-called “licensed band’) to carry the backhaul data between access points 102. For instance, WLAN 100 could use channels in the Advanced Wireless Services (AWS) band, the C band, or even in the E band if licensed to an operator and not available for common unlicensed use. For example, in one embodiment, access points 102 communicate over a reliable backhaul communication link 108 that is implemented over an LTE of 5Gnr datalink on channels licensed to an operator. In one embodiment, home gateway 104 identifies channels in an operator's network that are below certain power thresholds at that location (e.g., are available). The home gateway 104 then identifies such unused channels for use by the WLAN 100 to implement the reliable backhaul communication link 108. In this manner, unused portions of the licensed spectrum are repurposed locally by the WLAN to provide a reliable backhaul communication channel thereby freeing up the WLAN communication channel for data transmitted to and from client stations 110. Advantageously, in this embodiment, WLAN 100 operates at a very low power level on these licensed channels so as to not interfere with the normal outdoor operations of the licensed operator. Further, this low power mode is sufficient for the WLAN 100 because operation on these borrowed channels is maintained within the confines of the home or dwelling that houses the WLAN 100. In other embodiments, as described in more detail below, directional antennas can also be used to reduce interference with the operator's normal operation.

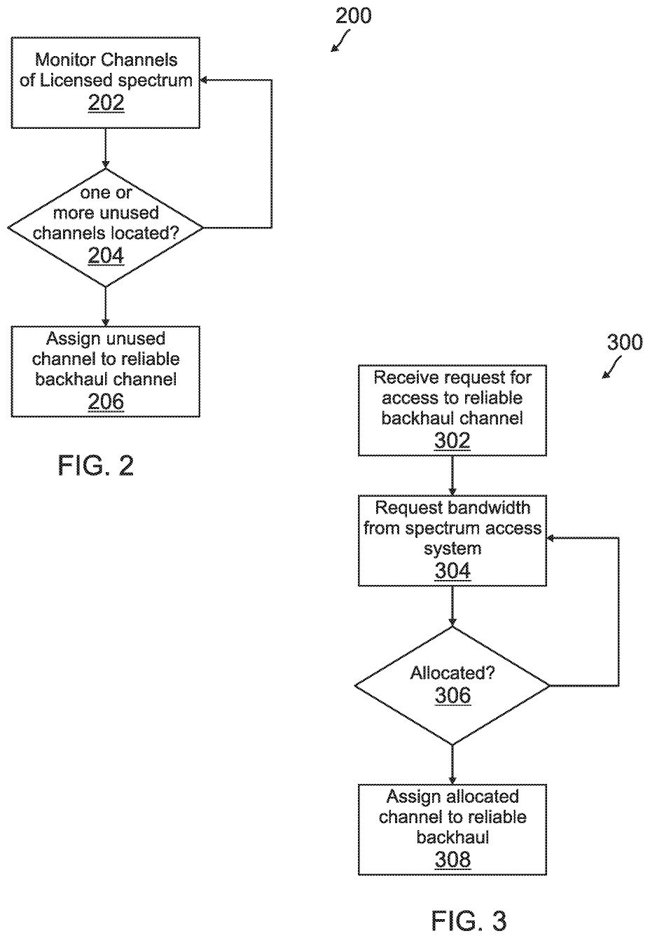

FIG. 2 is a flow diagram that illustrates one embodiment of a process 200 for allocating licensed spectrum for use as the reliable backhaul communication link. In this embodiment, home gateway 104 monitors the channels in the licensed spectrum for activity by user's of the service provider network at block 202. Alternatively, information on available channels is gathered by other entities in WLAN 100 (e.g., access points 102) and communicated to the home gateway 104. If, at block 204, the home gateway 104 determines that one or more unused channels have been identified, the home gateway 104 proceeds to assign the unused channel or channels for use by the reliable backhaul communication link 108 at block 206. If, at block 204, no channel is found, the home gateway 104 continues its search for unused channels at block 202 until unused channels are identified.

B. Automated Frequency Coordination (AFC)

In other embodiments, WLAN 100 uses an automated frequency paradigm to implement the reliable backhaul communication link 108 between access points 102. Such AFC systems use frequency coordination databases to facilitate spectrum sharing. AFC systems protect incumbent licensees or other users from interference caused by entrants with lower priority. The AFC systems also provide authoritative near real-time decisions on requests to transmit or assign usage rights. One example of an AFC system is the Citizens Broadband Radio Service (CBRS). When used to implement the reliable backhaul communication link of WLAN 100, a CBRS system relies on a spectrum access system (SAS) 112 granting WLAN 100 access to a portion of a shared frequency band. For example, FIG. 3 provides one embodiment of a process for allocating a channel to the reliable backhaul communication link 108 of WLAN 100 using a SAS 112. In this embodiment, process 300 receives a request for access to the reliable backhaul communication link 108 at block 302. At block 304, the process 300 requests bandwidth from the spectrum access system 112. At block 306, the process 300 determines when the bandwidth is allocated by the SAS 112. When allocated, the process 300 assigns the allocated bandwidth to the reliable backhaul communication link 108 for backhaul communications between access points 102 of WLAN 100.

In some embodiments, the use of the SAS 112 can provide additional benefits. For example, the SAS 112 can also be used to help reduce interference between neighboring mesh networks 114. In this case, the users of neighboring mesh networks 114 would opt-in to allow the SAS 112 to also control the channel of operation for the WLAN communications between the access points 102 and client stations 110. In one embodiment, the SAS 112 could reduce interference both with the reliable backhaul communication links 108, as well as with the UE links 116 (links from an access point 102 to a client station 110) by allocating channels with the least interference.

It is understood that CBRS is described as an example of an AFC system that can be used to implement the reliable backhaul link 108 of WLAN 100. In other embodiments, reliable backhaul communication link 108 is implemented using other AFC systems that automatically coordinate the sharing of frequency spectrum between users of services with different priority levels.

C. MMW

In other embodiments, WLAN 100 uses millimeter wave transmission for reliable backhaul communication link 108. Millimeter wave transmission can be operated in a home at low power thereby reducing the potential for interference with uses of the technology outside the home. Further, in a typical WLAN instantiation, adjacent access points are typically only separated by a few walls within the home and thus millimeter wave transmissions will have sufficient signal strength when received at an access point 102.

D. Directional Antennas (MIMO)

In other embodiments, WLAN 100 uses directional antennas at each access point 102 for reliable backhaul communication link 108. The directional antennas may be implemented in a (multiple-input multiple-output) MIMO configuration and operated at low power to provide a narrow beam signal path between access points. These directional antennas can be used with licensed band, CBRS and millimeter wave options described above.

II. Frequency Reuse in WLAN

The reliable backhaul communication techniques described above can be used to implement frequency reuse in a wireless local area network (WLAN) cluster or mesh.

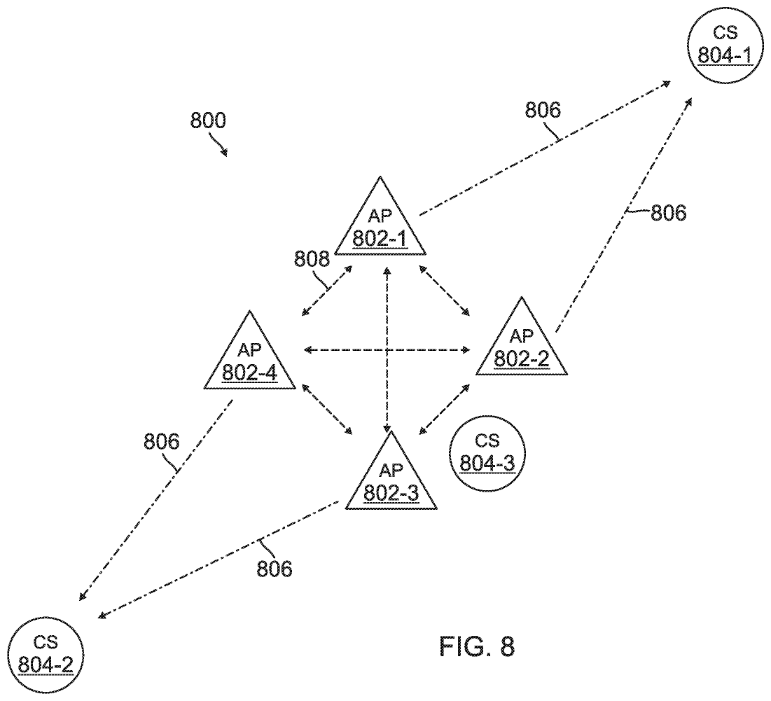

FIG. 8 is a block diagram illustrating one exemplary embodiment of a WLAN cluster 800 comprising a plurality of wireless local area network (WLAN) access points 802 that communicate with various client stations 804.

In the following description, a reference numeral that does not include a suffix (for example, the reference numeral “802”) is used to refer the corresponding entity generally, without regard to any particular instance of that entity depicted in FIG. 8. When a particular entity depicted in FIG. 8 is referred to, a reference numeral having a suffix that corresponds to that particular entity (for example, “802-2”) is used.

The WLAN access points 802 use a suitable wireless local area network protocol to communicate with the client stations 804 over unlicensed radio frequency spectrum. Each unlicensed RF channel used for such communications between the client stations 804 and the access points 802 is also referred to here as an “unlicensed user channel” 806.

In this exemplary embodiment, the access points 802 are configured to implement a single logical wireless local area network. For example, where an IEEE 802.11 protocol is used, the access points 802 can be configured in infrastructure mode to implement an extended service set (ESS) having a single service set identifier (SSID).

The access points 802, as a part of implementing such a single logical wireless local area network, typically need to communicate with one another to forward data communicated to and from the client stations 804 and to exchange control and management data.

In this exemplary embodiment, the access points 802 are also configured to wirelessly communicate with each other using licensed radio frequency spectrum (or unlicensed radio frequency spectrum that is managed by a spectrum access system (SAS)) using the reliable backhaul techniques described above. Each licensed (or unlicensed) RF channel used for such communications between the various access points 802 is also referred to here as a “reliable backhaul channel” 808.

The reliable backhaul techniques described above can be used to implement frequency reuse in the cluster 800 of FIG. 8. One example of a situation where such frequency reuse can be used is shown in FIG. 8.

In general, frequency reuse can be used when there is sufficient RF isolation between multiple groupings of access points 802 and client stations 804. These groupings are also referred to here as “reuse groups.” There is sufficient RF isolation between multiple reuse groups when the co-channel interference that results from simultaneously communicating different data on the same unlicensed user channel using the different reuse groups is tolerable (that is, where the resulting co-channel interference does not result in a substantial reduction in the throughput for such communications).

In the example shown in FIG. 8, there is sufficient RF isolation between a first reuse group and a second reuse group for the frequency reuse techniques described below to be used. In this example, the first reuse group comprises client station 804-1 and access points 802-1 and 802-2, and the second reuse group comprises client station 804-2 and access points 802-3 and 804-4.

In this example, if first data were communicated on the unlicensed user channel 806 between client station 804-1 and access points 802-1 and 802-2 and, at the same time, second data were communicated on the unlicensed user channel 806 between client station 804-2 and access points 802-3 and 802-4, there would be some degree of co-channel interference. However, if this co-channel interference would not result in a significant reduction in throughput for either reuse groups, then this interference would be tolerable, and the frequency reuse techniques described below can used with the first and second reuse groups.

In the example shown in FIG. 8, due to the location of client station 804-3, there is not sufficient RF isolation between client station 804-3 and any of the access points 802 to define a reuse group including that client station 804-3 that would be suitable for use with the frequency reuse techniques described below.

Reuse groups can be determined as a function of signal reception metrics captured at each of the access points 802 and/or client stations 804.

For example, in one implementation, each individual access point 802 can be configured to periodically make a reference transmission on the unlicensed user channel 806 containing data that is known to the client stations 804. In such an implementation, each client station 804 attempts to receive the reference transmission from that access point 802 and determines a signal reception metric (such as a signal-to-interference-plus-noise (SINR) value) for the reference transmission received from that access point 802.

Also, in such an implementation, each client station 804 can be configured to periodically make a reference transmission containing data that is known to the access points 802. In such an implementation, each access point 802 attempts to receive the reference transmission from that client station 804 and determines a signal reception metric (such as a SINR value) for that reference transmission received from that client station 804.

The various signal reception metrics can be communicated to the access points 802, which can coordinate with each other (using the reliable backhaul channel 808) to form various reuse groups for the purpose of implementing frequency reuse as described here.

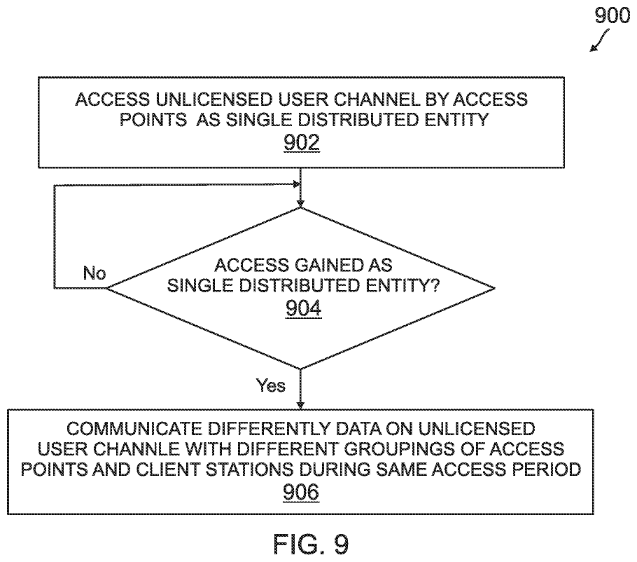

FIG. 9 is a flow diagram illustrating one exemplary embodiment of a method 900 of reusing a frequency in a wireless local area network. The embodiment of method 900 shown in FIG. 9 is described here as being implemented using the WLAN cluster 800 of FIG. 8, though it is to be understood that other embodiments can be implemented in other ways.

The blocks of the flow diagram shown in FIG. 9 have been arranged in a generally sequential manner for ease of explanation; however, it is to be understood that this arrangement is merely exemplary, and it should be recognized that the processing associated with method 900 (and the blocks shown in FIG. 9) can occur in a different order (for example, where at least some of the processing associated with the blocks is performed in parallel and/or in an event-driven manner). Also, most standard exception handling is not described for ease of explanation; however, it is to be understood that method 900 can and typically would include such exception handling.

Method 900 can be used when there is sufficient RF isolation between multiple reuse groups (that is, multiple groupings of access points and client stations 804). This is the case when the co-channel interference that results from simultaneously communicating different data on the same unlicensed user channel 806 using different reuse groups is tolerable (that is, where the resulting co-channel interference does not result in a substantial reduction in the throughput for such communications). In one implementation, such reuse groups are determined as described above in connection with FIG. 8.

Method 900 comprises accessing an unlicensed user channel 806, by the access points 802, as a single distributed entity (block 902). That is, the access points 802 in the cluster 800 coordinate with each other (using the reliable backhaul channel 808) so that it appears, from the perspective of other devices that may be attempting to access the same unlicensed user channel 806, that a single distributed entity is attempting to gain access to the unlicensed user channel 806

When attempting to gain access to the unlicensed user channel 806, the access points 802 can operate in a “repeater mode” in which all the access points 802 simultaneously transmit and receive the same protocol transmissions and use the same protocol values or periods (for example, the same random back off values) in connection with doing so.

Method 900 further comprises, when the access points 802 successfully gain access to the unlicensed user channel 806 as a single distributed entity (checked in block 904), communicating, on the unlicensed user channel 806 during the same access period, different data between multiple, different reuse groups (block 906). For example, for each such reuse group, during the access period, the one or more access points 802 in that reuse group can transmit the same data on the unlicensed user channel 806 to the one or more client stations 804 in that reuse group. Similar techniques can be used for communicating data from the client stations 804 to the access points 802.

Typically, after the access points 802 gain access to the user channel as a single distributed entity, the access points 802 would then continue to operate as a single distributed entity and make a single unicast transmission to a single client station 804 or make a single broadcast or multicast transmission of the same data to multiple client stations 804. However, with embodiments of method 900, after the access points 802 gain access to the unlicensed user channel 806 as a single distributed entity, different data is communicated between multiple, different groupings of access points 802 and client stations 804 during the same period that the access points 802 have gained access to the unlicensed user channel 806. Doing this can result in overall improved system throughput. This may not be the case, however, if the coordination between the access points 802 necessary to implement the frequency reuse must take place over the unlicensed user channel 806. This is because doing so would itself reduce overall system throughput. If, instead, the reliable backhaul channel 808 is used for such coordination, then the coordination itself will not reduce overall system throughput, which increases the number of opportunities where frequency reuse would be beneficial.

III. Latency Sensitivity

In another embodiment, the reliable backhaul communication link can be used to provide reliable bandwidth in WLAN 100 for communication between a home gateway 104 and a set top box 106. This can be accomplished by, for example, integrating an Access Point 102 into each of the home gateway 104 and the set top box 106. Alternatively, each of home gateway 104 and set top box 106 can be coupled to an access point (e.g., access points 102-1 and 102-4, respectively in FIG. 1). In this manner, home gateway 104 can communicate directly with set top box 106 over reliable backhaul communication link 108. In one embodiment, this reliable backhaul communication link 108 is used to carry data between home gateway 104 and set top box 106 when the data is sensitive to latency. For example, if a user is streaming a live event, such as the World Series or Super Bowl from an audio/video (A/V) source 120 such as the Internet or a cable or satellite provider coupled to the home gateway 104, this data can be prioritized for transmission over the reliable backhaul communication link 108 so that if the main channel of the WLAN 100 gets bogged down, the user is still able to view the event uninterrupted on A/V equipment 122 such as a receiver, television display, monitor or other appropriate A/V equipment coupled to the set top box 106. Thus, in addition to using the reliable backhaul communication link 108 to carry traffic between access points, it can also be used for other data that is sensitive to latency that can be introduced on the main channel of the WLAN 100.

IV. Control of WLAN Features and Upgrades

Various features of WLAN 100 of FIG. 1 can be modified from a base feature set offered by a service provider. These features include things such as bandwidth or service type used for the reliable backhaul communication link, data rates provided from the service provider, etc. In addition, the following other examples of features and upgrades are given by way of example and not by way of limitation:
1. Authorizing use of the reliable backhaul for user data based on the type of data, e.g., using the reliable backhaul for gaming devices.
2. Authorizing use of the reliable backhaul communication link based on the type of device, e.g., licensed and unlicensed devices.
3. Authorize devices that have built in capability to use the reliable backhaul communication link, e.g., televisions, gaming consoles, virtual reality/augmented reality headsets.
4. Authorize billing by device that uses the reliable backhaul communication link.

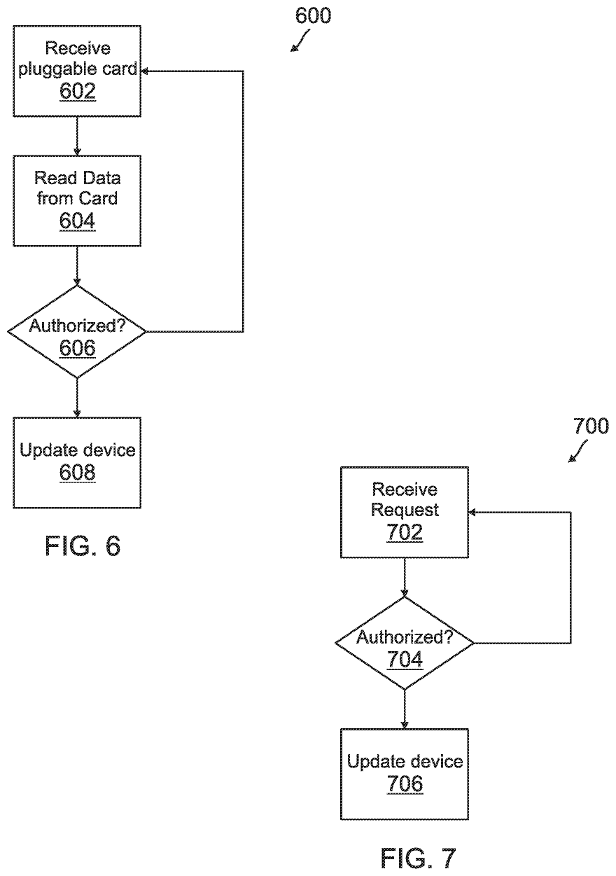

In one embodiment, features and upgrades are added by inserting a pluggable card into a slot of the set top box 106 or the home gateway 104. The pluggable card includes software code or an electronic chip to implement the feature or upgrade. FIG. 6 is a flow chart that illustrates one embodiment of a process 600 for upgrading or adding a feature to a home gateway or wireless local area network (WLAN). At block 602, a pluggable card is received at the home gateway. At block 604, data is read from the card. The data read from the card identifies the feature or upgrade to be added to the home gateway or WLAN. Additionally, the data read from the pluggable card may also include software code necessary to implement the feature on the home gateway. In other embodiments, the software for the added feature or upgrade is already stored on the home gateway or is downloaded from the Internet. At block 606, it is determined whether the upgrade or feature is authorized. For example, the process 600 determines if the user is authorized for the upgrade (has a fee been paid? Does the hardware platform support the upgrade?). If so, process 600 proceeds to block 608 and updates the home gateway or WLAN to implement the upgrade or feature. If not, the process returns to block 602.

Alternatively, in another embodiment, features are added to WLAN 100 using an application running on a client station that communicates with the set top box 106 or home gateway 104, e.g., a so-called “in-app purchase” made using an application running on a smart phone. An example of this process is shown and described with respect to FIG. 7. In process 700, a request is received at a server at block 702 from an application program running on a smart phone or other device on a WLAN that is connected to a service provider or equipment manufacturer through a home gateway. When the request is received, process 700 determines whether the requested upgrade or feature is authorized in a similar manner as described above with respect to FIG. 6. If the upgrade or feature is authorized, the process updates the device at block 706. If not, the process returns to block 702.

In either embodiment, the necessary software is loaded onto the set top box 106 or home gateway 104 to add the selected feature to WLAN 100. In some embodiments, the software is loaded on the gateway 104 or set top box 106 under the control of the service provider. In other embodiments, the software is loaded on the gateway 104 or the set top box 106 from the vendor that supplied the equipment. In either case, the upgraded service feature may be provided as a shared offering of the service provider and the equipment vendor.

V. WLAN Network Organization

The WLAN 100 of FIG. 1 can be organized using the techniques of self-organizing networks (SON). Advantageously, the reliable backhaul communication link 108 can be used by the process that organizes the network following SON techniques. Further, placement of access points and repeaters, in one embodiment, is assisted by the use of an application running on a smart phone. As access points are placed in WLAN 100, the application monitors signal strength at the access points from the various access points. The WLAN uses this information to determine adjustments to power levels, access point location and whether repeaters are needed in WLAN 100.

VI. Architecture for Set Top Box and Home Gateway

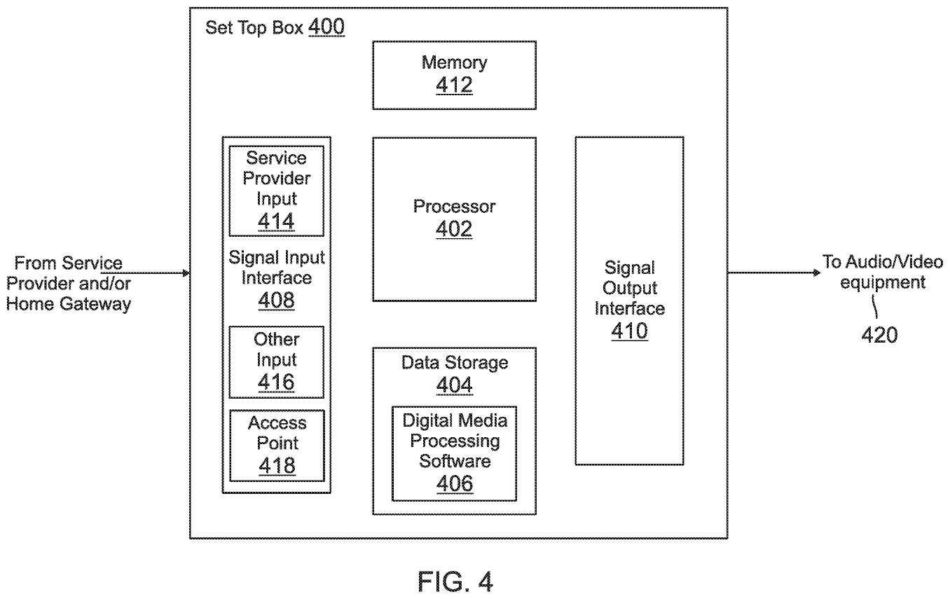

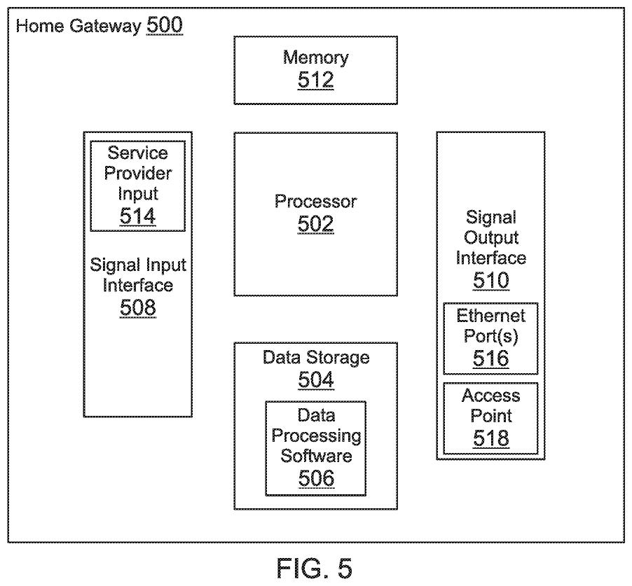

WLAN 100 includes a set top box 106 and a home gateway 104. FIGS. 4 and 5 are block diagrams that illustrate one embodiment of a set top box 400 and a home gateway 500 that can be used to implement set top box 106 and home gateway 104, respectively, of WLAN 100 of FIG. 1. In these embodiments, the set top box and home gateway are built around an architecture that uses a general-purpose processor rather than an application specific integrated circuit. The functionality is added through software. This represents an improvement in wireless LAN technology because this design has the advantage of lower cost compared to traditional equipment and is more flexible to upgrade after initial deployment. Further, various levels of service can be provided from the same hardware platform just by altering the software code on the equipment. The set top box and home gateway are described in turn below.

Set top box 400 is built around a general-purpose processor 402 rather than a chip set specifically designed to implement the functionality of the set top box. This general-purpose processor 402, in some embodiments, comprises a commercial off-the-shelf processor that is available at low cost because the processor is sold in high quantity, e.g., processor chip sets that are used in smart phones. The functionality of the set top box 400 is implemented by software code (digital media processing software 406) that is stored in data storage device 404 and run on general-purpose processor 402 in conjunction with memory 412.

Set top box 400 also includes signal input interface 408 and signal output interface 410. Signal input interface 408 includes, for example, circuitry to receive video and audio input from a service provider at a service provider input 414, e.g., a cable and/or a fiber optic input. Additionally, video and audio from other sources such as High Definition Multimedia Interface (HDMI) and Universal Serial Bus (USB) inputs are also available at other input 416 of signal input interface 408. Signal input interface 408 also, in some embodiments, includes an embedded access point 418 that is used to communicate with the home gateway 104. In this manner, video and/or audio content can be streamed from home gateway 104 to set top box 400 as another source of video and/or audio signal.

Signal output interface 410 provides the output of the set top box 400. Signal output interface 410 provides signals in formats for connection to audio/video equipment 420, e.g., a receiver, a television, a display, speakers and/or other devices for displaying video and broadcasting audio signals.

In operation, video and audio signals are received at signal input interface 408 of set top box 400. Processor 402 runs digital media processing software on general-purpose processor 402 to prepare the received video and audio signals for display. The output of the digital media processing software is provided to appropriate display and speakers by signal output interface 410.

Home gateway 500 is constructed in a similar manner to set top box 400 in that the architecture is built around a general-purpose processor—processor 502—rather than an application specific chip set such as designed for use in a Data Over Cable Service Interface Specification (DOCSIS), a Gigabit Passive Optical Network (GPON) or a Digital Subscriber Line (DSL) modem. As with processor 402, the general-purpose processor 502 is also an off-the-shelf processor. The functionality of the desired modem is implemented through data processing software 506 stored in data storage 504 and run on processor 502.

Home gateway 500 also includes signal input interface 508 and signal output interface 510. Signal input interface 508 includes, for example, circuitry to receive data input from a service provider at service provider input 514, e.g., a cable and/or a fiber optic input.

Signal output interface 510 provides the output of the home gateway 500. Signal output interface 510 provides signals in formats for transmission over a datalink. For example, interface 510 includes one or more ethernet ports 516 as well as a wireless access point 518. Thus, data may be communicated over either wired or wireless networks. In some embodiments, the access point 518 is located external to the home gateway 500. It is noted that video and/or audio content received at signal input interface 508 can be streamed from home gateway 500 to set top box 400 as another source of video and/or audio signal. In some embodiments, this streaming is accomplished over the reliable backhaul communication link 108 of FIG. 1 thereby providing good video quality even for signals that are sensitive to latency in the signal (e.g., live programming).

In operation, a data signal is received at signal input interface 508 of home gateway 500. Processor 502 runs data processing software 506 on general-purpose processor 502 to prepare the received signals. The output of the data processing software 506 is provided to an appropriate output by signal output interface 510, e.g., Ethernet port 516 or wireless access point 518.

The methods, systems and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a non-transitory storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Non-transitory storage devices or media suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially designed application-specific integrated circuits (ASICs) or Field Programmable Gate Arrays (FGPAs).

### Example Embodiments

Example 1 include a wireless local area network, comprising: a plurality of access points distributed in a location, wherein the plurality of access points form a mesh network; wherein the access points are configured to communicate with client stations over a frequency band used for wireless local area networks; and wherein the access points are configured to communicate backhaul data with each other over a reliable backhaul communication link in a frequency band that is different from a frequency band typically used for communication by wireless local area networks.

Example 2 includes the wireless local area network of example 1, wherein the reliable backhaul communication link comprises communication in a frequency band that is licensed to an operator.

Example 3 includes the wireless local area network of any of examples 1 and 2, wherein the reliable backhaul communication link comprises communication over a frequency band managed by an automated frequency coordination (AFC) System.

Example 4 includes the wireless local area network of example 3, wherein the AFC system comprises a Citizens Broadband Radio System (CBRS) is further configured to manage interference between adjacent wireless local area networks.

Example 5 includes the wireless local area network of any of examples 1-4, wherein the reliable backhaul communication link comprises communication over a millimeter wave communication link between adjacent access points.

Example 6 includes the wireless local area network of any of examples 1-5, wherein the reliable backhaul communication link comprises directional antennas in a multiple-input multiple output (MIMO) configuration.

Example 7 includes the wireless local area network of any of examples 1-6, wherein the reliable backhaul communication link is used to implement frequency reuse on the frequency band dedicated to the wireless local area network.

Example 8 includes the wireless local area network of any of examples 1-7, and further comprising: a set top box configured to be coupled to audio/video equipment; a home gateway coupled to a audio/video source; and wherein the set top box communicates with the home gateway over the reliable backhaul communication link.

Example 9 includes a method for a wireless local area network, the method comprising: communicating between a plurality of access points and client stations over a channel in an unlicensed frequency band; and communicating among the plurality of access points over a reliable backhaul communication link in a frequency band that is different from a frequency band typically used for communication by wireless local area networks.

Example 10 includes the method of example 9, wherein communicating among the plurality of access points over the reliable backhaul communication link comprises communicating in a frequency band that is licensed to an operator.

Example 11 includes the method of any of examples 9 and 10, wherein communicating among the plurality of access points over the reliable backhaul communication link comprises communicating over a frequency band managed by an Automated Frequency Coordination (AFC) system.

Example 12 includes the method of example 11, and further comprising managing interference between adjacent wireless local area networks with the AFC system, wherein the AFC system comprises a Citizens Broadband Radio System (CBRS).

Example 13 includes the method of any of examples 9-12, wherein communicating over the reliable backhaul communication link comprises communicating over a millimeter wave communication link between adjacent access points.

Example 14 includes the method of any of examples 9-13, wherein communicating over the reliable backhaul communication link comprises communicating over directional antennas in a multiple-input multiple output (MIMO) configuration.

Example 15 includes the method of any of examples 9-14, wherein communicating over the reliable backhaul communication link is used to implement frequency reuse on the frequency band dedicated to the wireless local area network.

Example 16 includes a method for allocating channels to a reliable backhaul communication link of a wireless local area network, the method comprising: monitoring channels in a frequency band licensed to an operator; and when one or more of the monitored channels in the frequency band licensed to the operator is available, assigning the one or more channels to the reliable backhaul communication link.

Example 17 includes the method of example 16, wherein monitoring channels comprises monitoring power levels of the channels in the frequency band licensed to the operator.

Example 18 includes the method of example 17, and further comprising determining that one of the monitored channels is available when a power level of the one of the monitored channels falls below a threshold.

Example 19 includes the method of any of examples 17 and 18, wherein monitoring channels comprises monitoring one or more of channels in an automated frequency coordination system such as a Citizens Broadband Radio System (CBRS), channels in the Advanced Wireless Services (AWS) band, channels in the C band, or channels in the E band if licensed to an operator and not available for common unlicensed use or channels in a millimeter wave frequency band.

Example 20 includes the method of any of examples 17-19, wherein when one or more channels of the monitored channels in the frequency band is not available, continuing to monitor channels in the frequency band licensed to the operator.

Example 21 includes a method for allocating channels to a reliable backhaul communication link, the method comprising: receive a request for access to the reliable backhaul communication link; request allocation of bandwidth from a spectrum access system to be used for the reliable backhaul communication link; and when allocated, assign the allocated bandwidth to the reliable backhaul communication link.

Example 22 includes the method of claim 21, wherein receiving the request for access to the reliable backhaul communication link comprises receiving the request from an access point.

Example 23 includes the method of any of examples 21 and 22, wherein requesting allocation of bandwidth comprises requesting allocation of bandwidth from an automated frequency coordination system.

Example 24 includes a set top box, comprising: a general-purpose processor; a data storage device that stores a digital media processing software; a signal input interface that is configured to receive input video and audio signals for processing by the general-purpose processor using the digital media processing software; a signal output interface that is configured to provide output video and audio signals for display; wherein the signal input interface includes an embedded access point that is configured to receive streamed data from a source of video and/or audio content over a reliable backhaul communication link; and wherein the digital media processing software, when run on the general-purpose processor, causes the set top box to prepare the received video and audio signals and to prepare the output video and audio signals for display.

Example 25 includes the set top box of example 24, wherein the signal input interface includes inputs adapted to be connected to one or more of coaxial cable, fiber optic cable, (High-Definition Multimedia Interface (HDMI) cable or Universal Serial Bus (USB) cable to receive data from one or more service providers.

Example 26 includes the set top box of any of examples 24 and 25, wherein the signal output interface is configured to receive output from the digital media processing software and to provide the output for reception by a display and speakers.

Example 27 includes a home gateway, comprising: a general-purpose processor; a data storage device that stores a data processing software; a signal input interface that is configured to receive input data signals for processing by the general-purpose processor using the data processing software; a signal output interface that is configured to provide output data signals to a local area network; wherein the signal output interface includes a wireless access point that provides streamed audio and/or video output for the home gateway over a reliable backhaul communication link; and wherein the data processing software, when run on the general-purpose processor, causes the home gateway to process the received input data signals and to prepare the output data signals for the local area network.

Example 28 includes the home gateway of example 27, wherein the signal input interface comprises one or more of a connector for a coaxial cable and a connector for a fiber optic cable that are configured to receive data from a service provide over a coaxial cable or a fiber optic cable, respectively.

Example 29 includes the home gateway of any of examples 28 and 29, wherein the signal output interface further includes one or more ethernet ports that provide streamed audio and/or video output for the home gateway.

Example 30 includes a method for upgrading a wireless local area network having a reliable backhaul communication link, the method comprising: receiving a request for upgrading the wireless local area network; authorizing the upgrade; and upgrading the wireless local area network.

Example 31 includes the method of example 30, wherein receiving the request for upgrading the wireless local area network comprises receiving a pluggable card at a home gateway of the wireless local area network.

Example 32 includes the method of example 31, wherein upgrading the wireless local area network further comprises reading data from the pluggable card that identifies a feature to be added to the home gateway or wireless local area network.

Example 33 includes the method of any of examples 31 and 32, wherein upgrading the wireless local area network includes downloading software from the pluggable card or from an external source.

Example 34 includes the method of any of examples 30-33, wherein upgrading the wireless local area network includes verifying that the upgrade has been paid for or the upgrade is supported by a hardware platform of the wireless local area network.

Example 35 includes the method of any of examples 30-34, wherein receiving the request for upgrading the wireless local area network comprises receiving the request from an application program running on a client device on the wireless local area network.

Example 36 includes the method of any of examples 30-35, wherein receiving the request comprises receiving the request to change a bandwidth or service type used for a reliable backhaul communication link in the wireless local area network.

Example 37 includes the method of any of examples 30-36, wherein receiving the request comprises receiving the request to use a reliable backhaul communication link of the wireless local area network based on a type of user data.

Example 38 includes the method of any of examples 30-37, wherein receiving the request comprises receiving the request to use a reliable backhaul communication link of the wireless local area network based a type of client station.

Example 39 includes the method of any of examples 30-38, wherein receiving the request comprises receiving the request to use a reliable backhaul communication link of the wireless local area network for a device that has built-in capability to use the reliable backhaul communication link.

What is claimed is:

1. A wireless local area network, comprising:
a plurality of access points distributed in a location, wherein the plurality of access points form a mesh network;
wherein the access points are configured to communicate with client stations over a frequency band used for wireless local area networks; and
wherein the access points are configured to communicate backhaul data with each other over a reliable backhaul communication link in a frequency band that is different from a frequency band typically used for communication by wireless local area networks.

2. The wireless local area network of claim 1, wherein the reliable backhaul communication link comprises communication in a frequency band that is licensed to an operator.

3. The wireless local area network of claim 1, wherein the reliable backhaul communication link comprises communication over a frequency band managed by an automated frequency coordination (AFC) System.

4. The wireless local area network of claim 3, wherein the AFC system comprises a Citizens Broadband Radio System (CBRS) is further configured to manage interference between adjacent wireless local area networks.

5. The wireless local area network of claim 1, wherein the reliable backhaul communication link comprises communication over a millimeter wave communication link between adjacent access points.

6. The wireless local area network of claim 1, wherein the reliable backhaul communication link comprises directional antennas in a multiple-input multiple output (MIMO) configuration.

7. The wireless local area network of claim 1, wherein the reliable backhaul communication link is used to implement frequency reuse on the frequency band dedicated to the wireless local area network.

8. The wireless local area network of claim 1, and further comprising:
a set top box configured to be coupled to audio/video equipment;
a home gateway coupled to a audio/video source; and
wherein the set top box communicates with the home gateway over the reliable backhaul communication link.

9. A method for a wireless local area network, the method comprising:
communicating between a plurality of access points and client stations over a channel in an unlicensed frequency band; and
communicating among the plurality of access points over a reliable backhaul communication link in a frequency band that is different from a frequency band typically used for communication by wireless local area networks.

10. The method of claim 9, wherein communicating among the plurality of access points over the reliable backhaul communication link comprises communicating in a frequency band that is licensed to an operator.

11. The method of claim 9, wherein communicating among the plurality of access points over the reliable backhaul communication link comprises communicating over a frequency band managed by an Automated Frequency Coordination (AFC) system.

12. The method of claim 11, and further comprising managing interference between adjacent wireless local area networks with the AFC system, wherein the AFC system comprises a Citizens Broadband Radio System (CBRS).

13. The method of claim 9, wherein communicating over the reliable backhaul communication link comprises communicating over a millimeter wave communication link between adjacent access points.

14. The method of claim 9, wherein communicating over the reliable backhaul communication link comprises communicating over directional antennas in a multiple-input multiple output (MIMO) configuration.

15. The method of claim 9, wherein communicating over the reliable backhaul communication link is used to implement frequency reuse on the frequency band dedicated to the wireless local area network.

16. A method for allocating channels to a reliable backhaul communication link of a wireless local area network, the method comprising:
monitoring channels in a frequency band licensed to an operator; and
when one or more of the monitored channels in the frequency band licensed to the operator is available, assigning the one or more channels to the reliable backhaul communication link.

17. The method of claim 16, wherein monitoring channels comprises monitoring power levels of the channels in the frequency band licensed to the operator.

18. The method of claim 17, and further comprising determining that one of the monitored channels is available when a power level of the one of the monitored channels falls below a threshold.

19. The method of claim 17, wherein monitoring channels comprises monitoring one or more of channels in an automated frequency coordination system such as a Citizens Broadband Radio System (CBRS), channels in the Advanced Wireless Services (AWS) band, channels in the C band, or channels in the E band if licensed to an operator and not available for common unlicensed use or channels in a millimeter wave frequency band.

20. The method of claim 17, wherein when one or more channels of the monitored channels in the frequency band is not available, continuing to monitor channels in the frequency band licensed to the operator.

21. A method for allocating channels to a reliable backhaul communication link, the method comprising:
receive a request for access to the reliable backhaul communication link;
request allocation of bandwidth from a spectrum access system to be used for the reliable backhaul communication link; and
when allocated, assign the allocated bandwidth to the reliable backhaul communication link.

22. The method of claim 21, wherein receiving the request for access to the reliable backhaul communication link comprises receiving the request from an access point.

23. The method of claim 21, wherein requesting allocation of bandwidth comprises requesting allocation of bandwidth from an automated frequency coordination system.

24. A set top box, comprising:
a general-purpose processor;
a data storage device that stores a digital media processing software;
a signal input interface that is configured to receive input video and audio signals for processing by the general-purpose processor using the digital media processing software;
a signal output interface that is configured to provide output video and audio signals for display;
wherein the signal input interface includes an embedded access point that is configured to receive streamed data from a source of video and/or audio content over a reliable backhaul communication link; and
wherein the digital media processing software, when run on the general-purpose processor, causes the set top box to prepare the received video and audio signals and to prepare the output video and audio signals for display.

25. The set top box of claim 24, wherein the signal input interface includes inputs adapted to be connected to one or more of coaxial cable, fiber optic cable, (High-Definition Multimedia Interface (HDMI) cable or Universal Serial Bus (USB) cable to receive data from one or more service providers.

26. The set top box of claim 24, wherein the signal output interface is configured to receive output from the digital media processing software and to provide the output for reception by a display and speakers.

27. A home gateway, comprising:
a general-purpose processor;
a data storage device that stores a data processing software;
a signal input interface that is configured to receive input data signals for processing by the general-purpose processor using the data processing software;
a signal output interface that is configured to provide output data signals to a local area network;
wherein the signal output interface includes a wireless access point that provides streamed audio and/or video output for the home gateway over a reliable backhaul communication link; and
wherein the data processing software, when run on the general-purpose processor, causes the home gateway to process the received input data signals and to prepare the output data signals for the local area network.

28. The home gateway of claim 27, wherein the signal input interface comprises one or more of a connector for a coaxial cable and a connector for a fiber optic cable that are configured to receive data from a service provide over a coaxial cable or a fiber optic cable, respectively.

29. The home gateway of claim 28, wherein the signal output interface further includes one or more ethernet ports that provide streamed audio and/or video output for the home gateway.

30. A method for upgrading a wireless local area network having a reliable backhaul communication link, the method comprising:
receiving a request for upgrading the wireless local area network;
authorizing the upgrade; and
upgrading the wireless local area network.

31. The method of claim 30, wherein receiving the request for upgrading the wireless local area network comprises receiving a pluggable card at a home gateway of the wireless local area network.

32. The method of claim 31, wherein upgrading the wireless local area network further comprises reading data from the pluggable card that identifies a feature to be added to the home gateway or wireless local area network.

33. The method of claim 31, wherein upgrading the wireless local area network includes downloading software from the pluggable card or from an external source.

34. The method of claim 30, wherein upgrading the wireless local area network includes verifying that the upgrade has been paid for or the upgrade is supported by a hardware platform of the wireless local area network.

35. The method of claim 30, wherein receiving the request for upgrading the wireless local area network comprises receiving the request from an application program running on a client device on the wireless local area network.

36. The method of claim 30, wherein receiving the request comprises receiving the request to change a bandwidth or service type used for a reliable backhaul communication link in the wireless local area network.

37. The method of claim 30, wherein receiving the request comprises receiving the request to use a reliable backhaul communication link of the wireless local area network based on a type of user data.

38. The method of claim 30, wherein receiving the request comprises receiving the request to use a reliable backhaul communication link of the wireless local area network based a type of client station.

39. The method of claim 30, wherein receiving the request comprises receiving the request to use a reliable backhaul communication link of the wireless local area network for a device that has built-in capability to use the reliable backhaul communication link.
